(19) United States
(12) Patent Application Publication
(10) Pub. No.: US 2015/0078462 A1
(43) Pub. Date: Mar. 19, 2015

(54) LINE CURRENT DIFFERENTIAL PROTECTION METHOD AND SYSTEM USING BROADBAND POWER LINE CARRIER OVER HIGH VOLTAGE TRANSMISSION LINES

(71) Applicant: GridEdge Networks, Inc., Littleton, MA (US)

(72) Inventors: Nachum Sadan, Carlisle, MA (US); Darrell Furlong, Hollis, NH (US); Norm Strandberg, Westford, MA (US); Bruce Renz, Columbus, OH (US)

(21) Appl. No.: 14/332,656

(22) Filed: Jul. 16, 2014

Related U.S. Application Data
(60) Provisional application No. 61/847,759, filed on Jul. 18, 2013.

(51) Int. Cl. H04B 3/56; H04B 3/54

(52) U.S. Cl. CPC H04B 3/56; H04B 3/544; H04B 2203/5479; H04B 2203/5425
USPC 375/257

(57) ABSTRACT

A method and system for connecting to line protection relays and providing a communications channel between a first end and a second end of high voltage transmission lines for digital Line Current Differential Protection are disclosed. At each of the first end and the second end of the high voltage transmission lines, a Broadband Power Line Carrier (BPLC) gateway device is connected to the line protection relay. The BPLC gateway has a coupling device to physically attach to the line and is configured to transmit and receive data communications over the high voltage transmission lines so as to allow the protection relays to communicate with each other via the existing high voltage transmission lines.

### CROSS-REFERENCE TO RELATED APPLICATION

This application claims priority under 35 USC §119 to U.S. Provisional Patent Application No. 61/847,759 filed on Jul. 18, 2013, whose entire contents are hereby incorporated by reference in their entirety.

### TECHNICAL FIELD

The present invention relates generally to Line Current Differential Protection or LCDP and, more particularly, to applying Broadband Power Line Carrier technology, also known as BPLC, to LCDP. LCDP is used by electric utilities for protection of high voltage transmission lines between substations.

### BACKGROUND OF THE INVENTION

Traditionally, utilities have used various communications technologies for line protection: fiber optic cables, and telephone copper wire (a.k.a pilot wire). For decades, utilities used multiple electro-mechanical relays employing analog communications schemes to coordinate their operation. In recent years utilities have been modernizing their substations and replacing the old analog systems with new digital relays that are capable of LCDP. Digital LCDP requires a fast digital communications channel between substations, with sufficient bandwidth to continuously transmit electrical waveform information. Copper pilot wire for analog LCDP schemes and fiber optic cables for digital LCDP schemes are the only known wired media used by utilities today. They both have advantages and disadvantages. The copper pilot wire has usually been deployed by the local phone company and leased as a service to the utility. Due to aging and deterioration causing a high failure rate, copper theft, and changing economic conditions (e.g., carriers switching to wireless cellular technologies), many phone companies stopped delivering this service. Utilities that own private copper wires have been plagued with high failure rates causing mis-operations and maintenance problems. Analog pilot wire systems have typically been used on lines below 138 kV, having distances of less than 15 miles. The use of fiber optics cables, such as OPGW (Optical Ground Wire), has been more common on new long Extra High Voltage (345 kV and above) lines because of its high installation costs.

Currently, digital LCDP requires an expensive optical (fiber optic) communications channel in order to satisfy the relay's speed, latency, symmetry and reliability demands. Conventional wisdom indicated that communications over a high voltage power line could not satisfy these demands.

### SUMMARY OF THE INVENTION

The present invention provides a method and system for plug-and-play communications between digital relays employed for Line Current Differential Protection (LCDP) applications. Digital LCDP has strict requirements with respect to high availability, latency, security and jitter for its point-to-point communications channel. The present invention uses the existing high voltage transmission lines combined with Broadband Power Line Carrier (BPLC) technology. The BPLC technology is a general purpose communications platform and has been modified and optimized for LCDP applications.

The first aspect of the present invention is a method for connecting to line protection relays and providing a plug-and-play communications channel between a first end and a second end of high voltage transmission lines for digital Line Current Differential Protection (LCDP), wherein the line protection relays comprise a first protection relay at the first end and a second protection relay at the second end, the method comprising connecting a first gateway device to the first protection relay and connecting a second gateway device to the second protection relay, the first gateway device and the second gateway device configured to communicate with each other over the high voltage transmission lines so as to provide a seamless communications channel between the first protection relay and the second protection relay.

According to an embodiment of the present invention, each of the protection relays is a digital relay communicating over existing serial and fiber interfaces between the first end and the second end.

According to an embodiment of the present invention, each of the first gateway device and the second gateway device comprises a Broadband Power Line Carrier (BPLC) device, the BPLC device comprising a coupling device configured to transmit communication signals to the high voltage transmission lines and to receive communication signals from the high voltage transmission lines.

According to an embodiment of the present invention, each of the protection relays is a digital relay configured for serial time divisional multiplexing (TDM) synchronous communications over fiber, wherein the serial time divisional multiplexing synchronous communications use a 64 Kbps to 128 Kbps communication rate.

According to an embodiment of the present invention, the plug-and-play method further comprises converting the TDM synchronous communications to an Ethernet protocol at the first end, and converting the Ethernet protocol to the TDM synchronous communications at the second end of the high voltage transmission lines for seamless communications from the first end to the second end, and vice versa for seamless communications from the second end to the first end.

According to an embodiment of the present invention, the method further comprises jitter buffering the communications from the first end to the second end and vice versa, so as to reduce jitter associated with said communications, wherein the jitter buffering has a center set point and is configured to detect high (overshoot) and low (undershoot) conditions and to reset an associated jitter buffer for maintaining nominal operation of the communications channel if these conditions occur.

According to an embodiment of the present invention, each of the first gateway device and the second gateway device comprises a BPLC modem, said method further comprising use of configuration settings to reduce the speed of the BPLC modem so as to adapt to a 64 Kbps or 128 Kbps data stream, wherein bits per carrier (BPC) values of the modem are used to increase a signal-to-noise ratio (SNR) so as to modify bandwidth for increased stability of the communications channel.

According to an embodiment of the present invention, the first gateway device and the second gateway device each comprises a Broadband Power Line Carrier (BPLC) modem device, the BPLC comprising a coupling device configured to transmit communication signals to the high voltage transmission lines and to receive communication signals from the high voltage transmission lines, wherein a configuration setting in the modem is used to reduce latency and jitter of the communications channel.

According to an embodiment of the present invention, the first gateway device and the second gateway device each comprises a multi-port Ethernet switch configured as a “traffic cop” in the converting from the TDM synchronous communications to the Ethernet protocol and from the Ethernet protocol to the TDM synchronous communications.

According to an embodiment of the present invention, the method further comprises use of phase combiners in the coupling device so as to provide a common mode noise cancellation and radiated emission reduction along said communications channel.

The second aspect of the present invention is a system for connecting to line protection relays and providing a plug-and-play communications channel between a first end and a second end of high voltage transmission lines for digital Line Current Differential Protection (LCDP), wherein the line protection relays comprise a first protection relay at the first end and a second protection relay at the second end, the system comprising a first gateway device connected to the first protection relay; and a second gateway device to the second protection relay, the first gateway device and the second gateway device configured to communicate with each other over the high voltage transmission lines so as to provide the seamless communications channel between the first protection relay and the second protection relay.

According to an embodiment of the present invention, the first gateway device and the second gateway device each comprises a Broadband Power Line Carrier (BPLC) modem device, the BPLC device comprising a coupling device configured to transmit communication signals to the high voltage transmission lines and to receive communication signals from the high voltage transmission lines.

According to an embodiment of the present invention, the communication signals are delivered over two or three phases of the high voltage transmission lines, the BPLC device further comprising a combiner configured to combine the communication signals from the two or three phases of high voltage transmission lines.

According to an embodiment of the present invention, the BPLC device is configured to convert the TDM synchronous communications to an Ethernet protocol at the first end of the high voltage transmission lines, and to convert the Ethernet protocol to the TDM synchronous communications at the second end of the high voltage transmission lines for communications from the first end to the second end, and vice versa for communications from the second end to the first end.

According to an embodiment of the present invention, the system comprises a jitter buffer configured to reduce jitter in the communications between the first end and the second end of the high voltage transmission lines.

### BRIEF DESCRIPTION OF THE DRAWINGS

FIG. 1 is a diagram that depicts a BPLC communications channel between two LCDP relays using two links.

FIG. 2 is a connection diagram of the BPLC system inside the control building of a substation.

FIG. 3 is a diagram that depicts an internal block diagram of a typical BPLC gateway.

FIG. 4 is a diagram that illustrates the physical layer of the BPLC data path.

FIG. 5 is a list of useful definitions of terms that are used in the specification.

FIG. 6 is a diagram that illustrates the possible sources of jitter in a BPLC communications network.

FIG. 7 is a block diagram that shows a point to point BPLC network between two relays using Serial TDM-to-Ethernet converters.

FIG. 8 is a jitter diagram that illustrates the implementation of a jitter buffer to smooth the bursty Ethernet packet traffic from the BPLC modem before it is presented to the synchronous TDM interface.

FIG. 9 is a time versus buffer size chart that depicts the operation of the jitter buffer over a period of time.

FIG. 10 is a time versus buffer size chart that illustrates a recovery from an underrun condition in the jitter buffer.

FIG. 11 is a flow chart that illustrates a calculation of the jitter buffer parameters needed to meet the LCDP requirements.

FIG. 12 is a diagram that illustrates how a TDM frame is being encapsulated inside an Ethernet packet.

FIG. 13 is a chart that shows the number of carriers in a BPLC modem under various configurations.

FIG. 14 is a chart that illustrates a Bits per Carrier (BPC) map of a BPLC modem.

### DETAILED DESCRIPTION OF THE INVENTION

The present invention uses Broadband Power Line Carrier (BPLC) for the protection of high voltage transmission lines between electrical power substations. In particular, BPLC technology is used on Line Current Differential Protection (LCDP). LCDP is used for the protection of high voltage transmission lines between substations. The LCDP protocol is implemented in digital devices called line protection relays. The line protection relays are typically located in a control building inside the substation. When a line fault (short circuit) is detected, the relay trips a breaker that electrically opens and thus physically isolates the fault. This action stops the propagation of the fault and limits the power outage to a smaller controlled area. When the fault is removed, the relay closes the breaker, restoring power to the affected area. Digital LCDP requires a fast communications channel between the relays in order to react quickly to a fault. The desired relay response time is two or three power cycles from the detection of the fault by the local relay until tripping of the breaker by the remote relay. The relays also have an asymmetry requirement in a matter of milliseconds (asymmetry is defined as the difference between TX direction and RX direction arrival times).

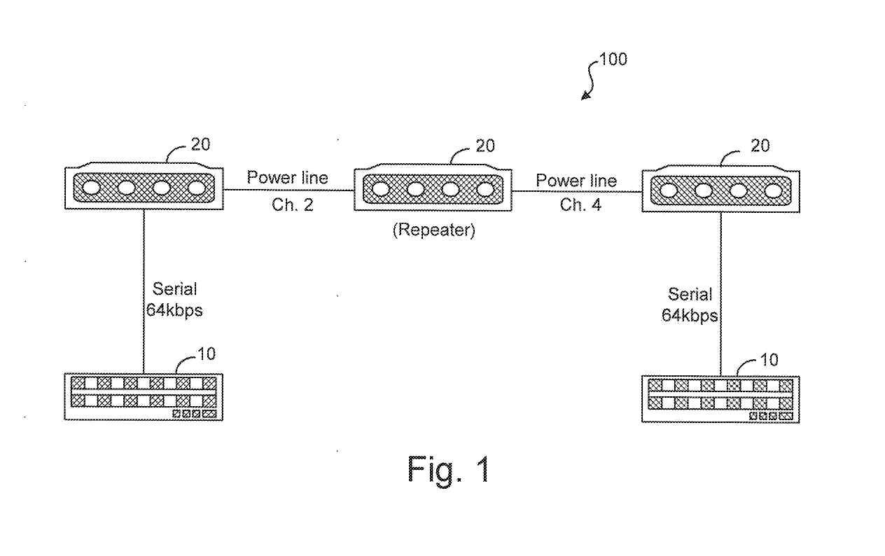

FIG. 1 is a diagram that depicts a BPLC communications channel between two LCDP relays using two links. As depicted in FIG. 1, the communications channel 100 is provided between a first end of the high voltage transmission lines and a second end of the high voltage transmission lines for digital Line Current Differential Protection (LCDP). The first and second ends each has a differential relay or digital relay 10 connected to a Broadband Power Line Carrier (BPLC) gateway device 20. As such, the communications between the digital relays 10 located at the first and second ends can be carried out over the high transmission lines via the BPLC gateway devices 20.

In one embodiment of the present invention, a third BPLC gateway device 20 is provided between the first end and the second end of the high transmission lines for use as a signal repeater or signal regenerator. The use of the third BPLC gateway device 20 as a signal repeater or regenerator has the benefit of extending the distance between the two station relays. Each of the first and second ends of the high transmission lines can be located in a substation. In each substation, the BPLC gateway device 20 connects to the 64 kbps synchronous port of the digital relay 10, according to one embodiment of the present invention. The integration with the relay is seamless and does not require configuration changes. The BPLC channel can be used over existing serial and fiber interfaces. Thus, there is no difference in the operation of the relays over a fiber optic cable or over a BPLC channel. This is also being called “plug and play” communications.

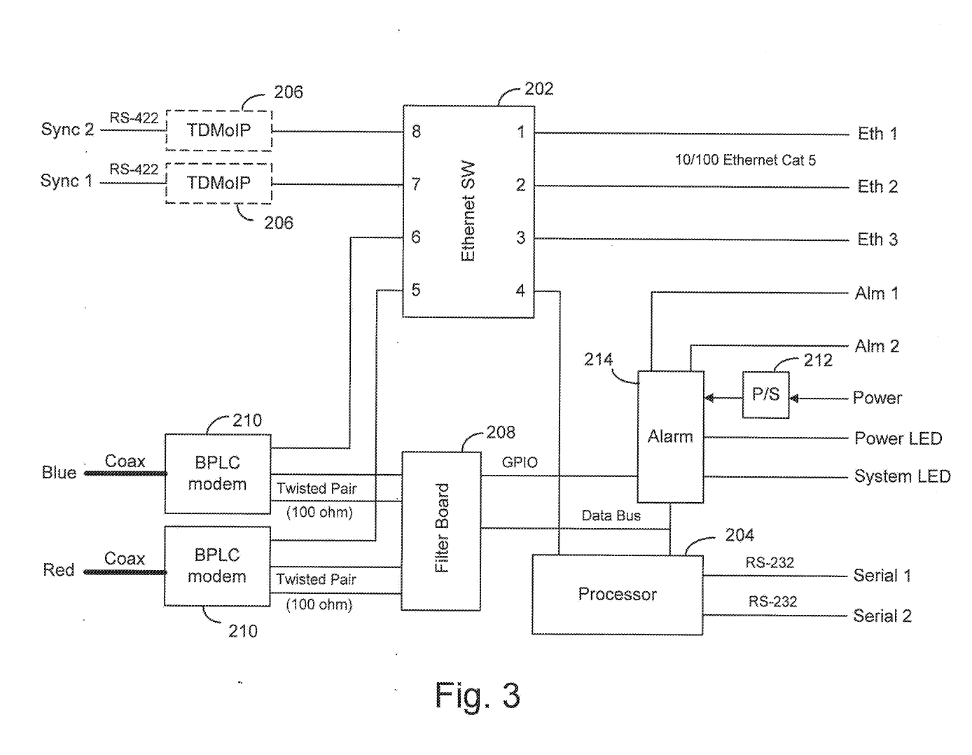

The BPLC modems (see FIG. 3) inside the BPLC gateway device 20 are responsible for the delivery of the relay data over the high voltage transmission lines. The description of the powerline communications can be found in U.S. Pat. No. 8,212,379: “Station Communications over Electrical Transmission Lines”, for example.

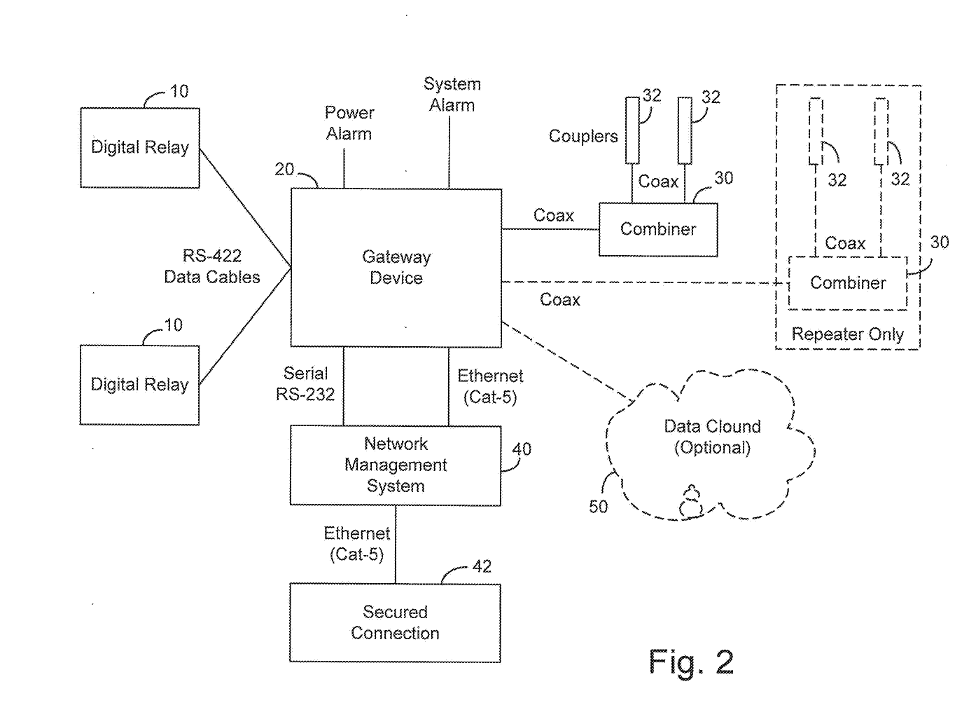

FIG. 2 is a connection diagram of the BPLC system inside the control building of a substation, according to one embodiment of the present invention. The BPLC gateway device 20 is connected to the digital relays 10 over a synchronous serial port. The wired connections that deliver the high frequency BPLC signal to/from the BPLC modems (see FIG. 3) inside the gateway device to a phase combiner device 30 are coax cables. The combiner 30 is located on the bus structure of the substation and is configured to combine BPLC signals from two or three phases of the high voltage transmission lines. The physical devices that inject the BPLC signal on the transmission lines are couplers 32. The couplers 32 are connected to the combiner 30 with coax cables. The gateway device 20 also provides alarms and may optionally be connected to a network management system 40 that allows for remote access through a secure connection 42. Details of the coupler 32 can be found in U.S. Pat. No. 7,535,785, for example.

FIG. 3 is a diagram that depicts an internal block diagram of a BPLC gateway device 20. At the center of the system is an Ethernet switch 202. As shown, the Ethernet switch 202 has eight ports. Two of the ports (5 & 6) are connected to BPLC modems 210 inside the BPLC gateway devices 20 (see FIG. 2); one port (4) is connected to a network processor 204; two ports (7 & 8) are connected to Time Division Multiplex (TDM)-to-Ethernet converters 206; and the remaining three ports (1, 2 & 3) are exposed for external connections. The BPLC modems 210 have external RF ports that connect to the couplers 32 via a combiner (see FIG. 2). A band pass filter board 208 is connected to the BPLC modems 210, acting as an analog front end circuit. The network processor 204 contains embedded software that configures and controls the various modules in the system. The network processor 204 has two asynchronous serial ports, one for console management, and the other for external use. Each of the TDM-to-Ethernet converters 206 has an interface to the external LCDP relays over synchronous serial ports and convert the serial relay's TDM data frames to Ethernet packets. The alarm board 214 is connected to an external power source through a switch 212. The alarm board 214 provides electrical power, alarms and user interface light-emitting diode indicators.

According to an embodiment of the present invention, the first end and the second end of the high voltage transmission lines each has a digital relay 10 connected to a BPLC gateway device 20 (see FIG. 1), and communications can be provided from the first end to the second end and vice versa. The TDM-to-Ethernet converter 206 at one end is configured to convert the TDM synchronous communications to an Ethernet protocol, and the TDM-to-Ethernet convert 206 at the other end is configured to convert from the Ethernet protocol to the TDM synchronous communications. Each of the TDM-to-Ethernet converters 206 is capable of converting one Synchronous Interface (64/128 kpbs) to and from Ethernet frames. Thus, the digital relays 10 (see FIGS. 2 and 3) can be configured for 64 kpbs or 128 kpbs TDM synchronous communications.

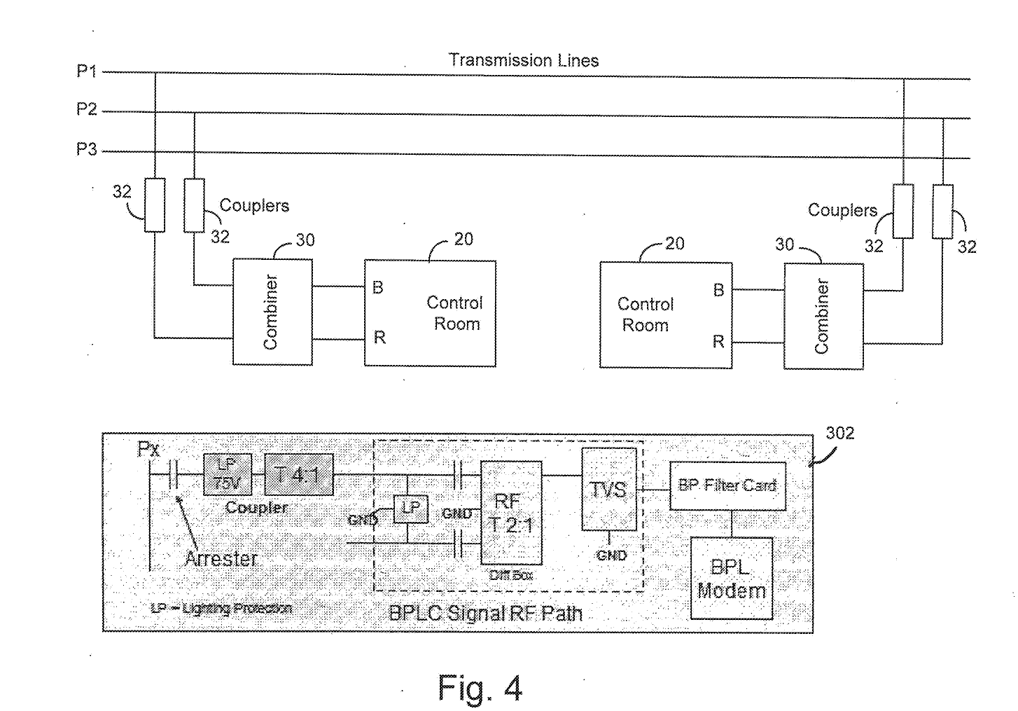

FIG. 4 is a diagram that illustrates the physical layer of the BPLC data path. The two BPLC modems 210 (see FIG. 3) inside each BPLC gateway device 20 are marked as Red (R) and Blue (B). These BPLC modems connect to a combiner 30 in the switchyard via coax cables. The combiner 30 is connected to the BPLC couplers 32 that are physically attached to the transmission lines via coax cables. In the couplers 32 and inside the combiner 30, lightning protection circuits 302 may be provided for lightning protection. The details of the lightning protection circuits can be found in U.S. Pat. No. 8,212,379 “Station Communications over Electrical Transmission Lines”, for example.

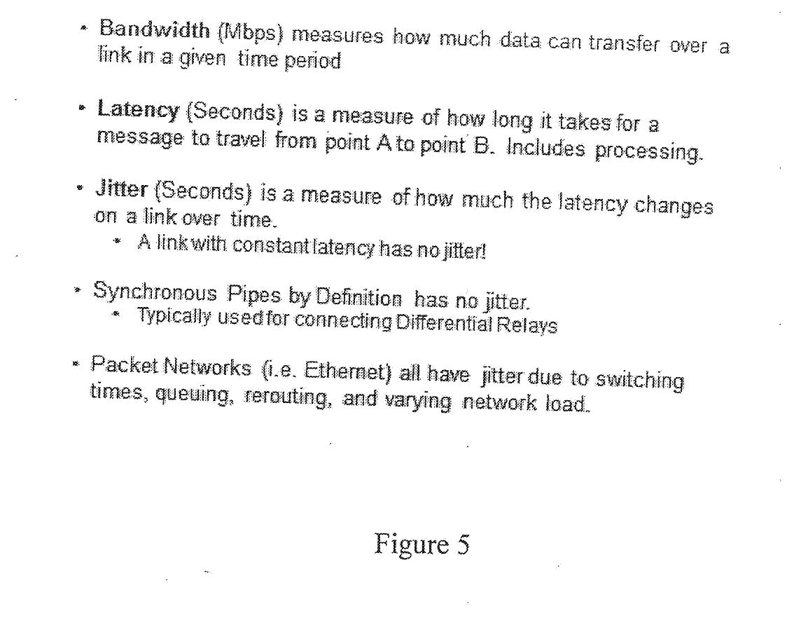

FIG. 5 is a list of useful definitions of terms that are used in this specification. Bandwidth or data rate is measured in megabits or kilobits per second. Latency or delay is measured in milliseconds, and jitter or delay variation is also measured in milliseconds. Control of latency and jitter is a significant technical challenge.

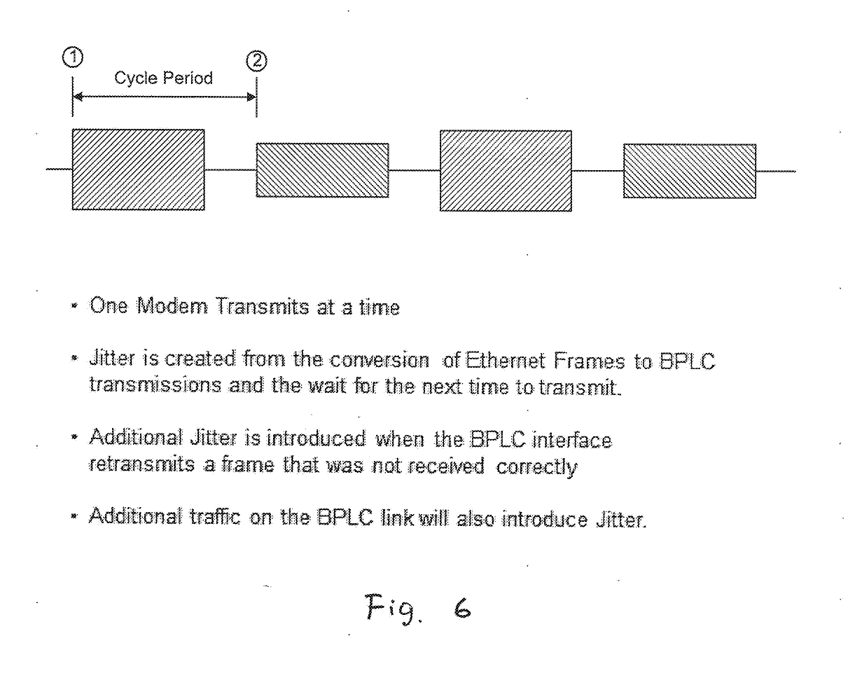

FIG. 6 is a diagram that illustrates the sources of jitter in a BPLC communications network. Inherently, an Ethernet network is not deterministic. Since there is a difference in the travel time of packets, the Ethernet network is a source of jitter. Furthermore, the BPLC communications network is half duplex, meaning that at any given time there may be either a transmission of a packet or a reception of a packet but not both simultaneously. This half-duplex communications scheme is a cause of increased latency and asymmetry. Latency and jitter also increase when there are retransmissions due to impairments on the physical line. Therefore, it is not uncommon for high voltage transmission lines to pick up radiated and conducted noise. In the substation where the BPLC gateway device is located, the bus structure and transformers is a harsh environment for the BPLC signal. Maintaining reliable communications and in addition controlling latency and jitter is a substantial technical challenge.

In order to reduce jitter associated with BPLC communications between the first and the second end of the high voltage transmission lines, jitter buffering is implemented. In jitter buffering, jitter buffers are used to smooth the synchronous communications and to deliver a deterministic 64 kpbs or 128 kpbs data stream.

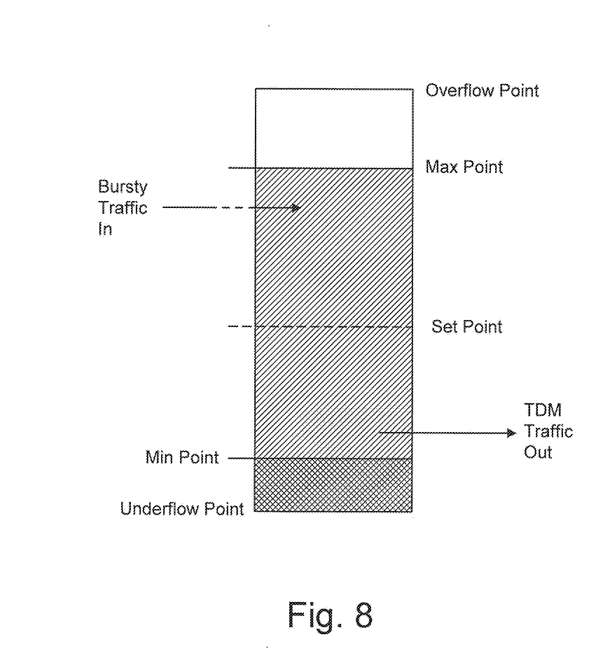

An example of jitter buffering is shown in FIG. 8.

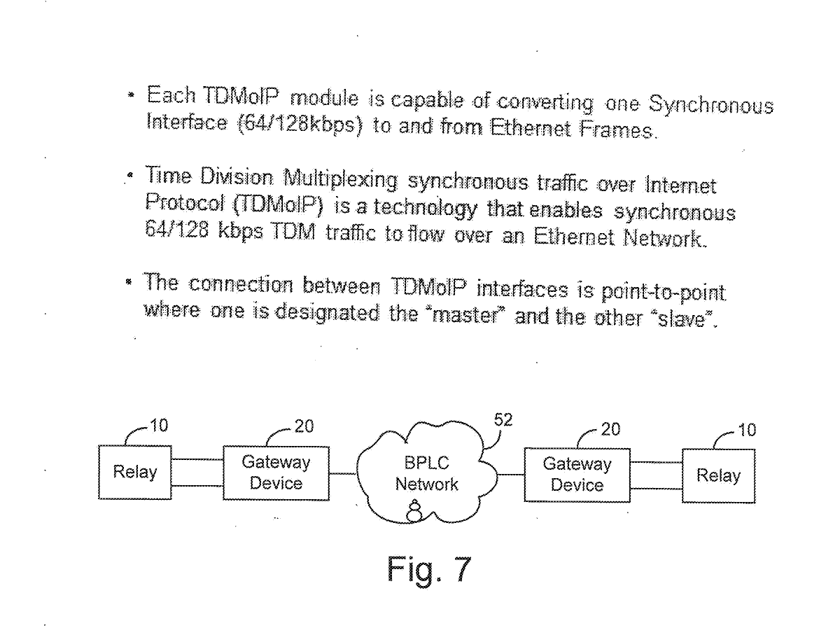

FIG. 7 is a block diagram that shows a point-to-point BPLC communications network between two digital relays using Serial TDM-to-Ethernet converters. According to an embodiment of the present invention, the Serial TDM-to-Ethernet converters 206 (see FIG. 3) provide a media adaptation from a serial RS-422 interface to an Ethernet RJ45 port, and protocol conversion from Sonet TDM-to-Ethernet IP. This functionality is also called TDM over Ethernet. The digital relays can also be connected to the communications gateway from the first end to the second end of the high voltage transmission lines via a fiber optic interface (not shown). Regardless of the hardware physical layer interface and the media adaptation to Ethernet, for all cases the relay software is configured to use the same communications protocol that is used with a native fiber communication channel. The TDM-to-Ethernet protocol converter converts a TDM frame to an Ethernet packet and vice versa while maintaining clock information and synchronization. For illustration purposes, where two gateway devices 20 and two digital relays 10 are used for connections on both ends of a BPLC communications network 52 as shown in FIG. 7, the TDM-to-Ethernet interface in one gateway device 20 is designated as the “master” and the TDM-to-Ethernet interface in the other gateway device 20 is the “slave”.

FIG. 8 is a jitter diagram that illustrates the implementation of a jitter buffer to smooth the bursty Ethernet packet traffic from the BPLC modem before it is presented to the synchronous TDM interface. According to an embodiment of the present invention, the jitter buffer uses a middle Set Point, a high threshold (Max Point) and low threshold (Min point) for jitter buffering. As data packets come in at various times they are entered into the jitter buffer. They are fed out of the jitter buffer at set intervals of time (for example every 8 milliseconds), making the traffic at the output side deterministic. Normally the filling and emptying operations of the jitter buffer happen around the middle Set Point. In cases where the high and low thresholds are reached, an overflow or underflow condition will happen. This triggers a reset of the jitter buffer operation in order to keep up with the rest of the data stream. Thus, jitter buffering is used to detect high (overshoot) and low (undershoot) conditions and to rest any associated jitter buffer in order to maintain normal operation of the BPLC communications channel.

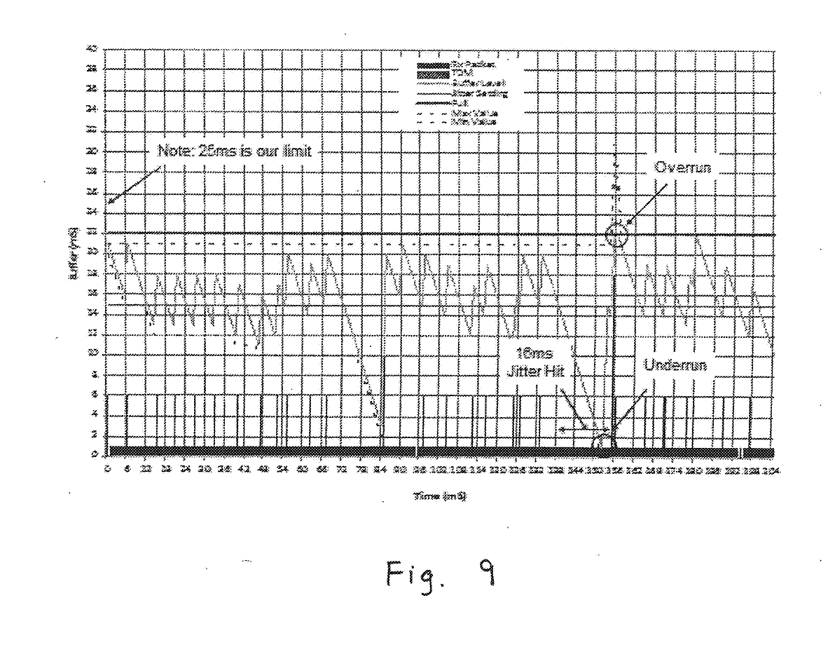

FIG. 9 is a time versus buffer size chart that depicts the operation of the jitter buffer over a period of time. An Overrun or Underrun condition occurs when the jitter is higher than the configured threshold. Since the jitter buffer parameters are under software control, the jitter buffer's limits can be optimized for the required application.

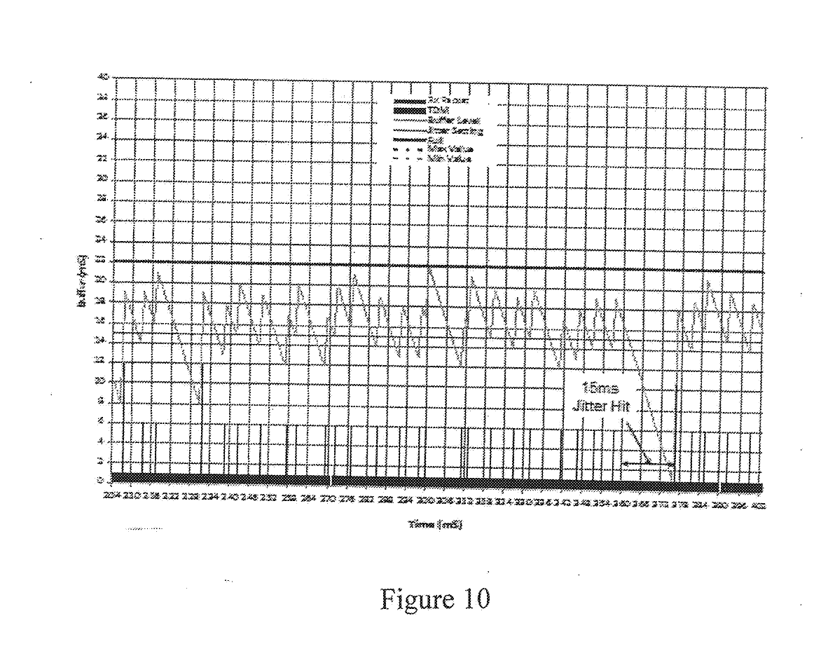

FIG. 10 is a time versus buffer size chart that illustrates a recovery from an Underrun condition in the jitter buffer. The software algorithm that controls the jitter buffer's operation detects the Underrun condition and resets the interface. The rest of the data stream continues its normal data transmission.

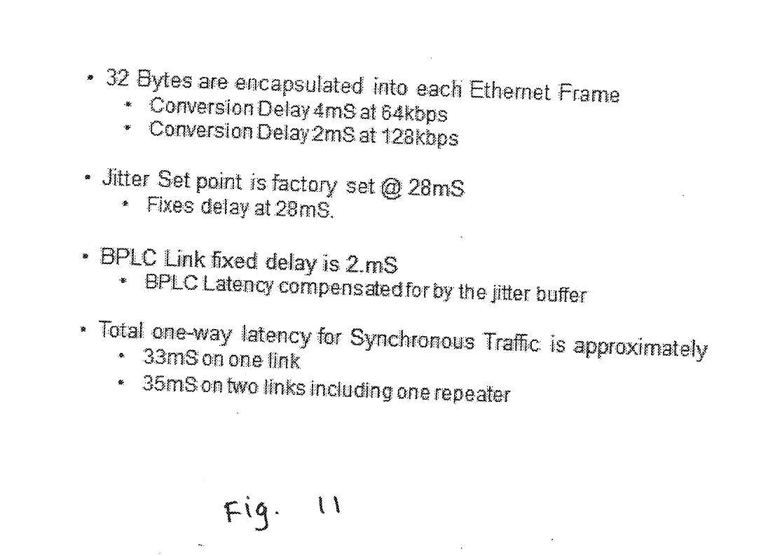

FIG. 11 is a flow chart that illustrates a calculation of the jitter buffer parameters needed to meet the LCDP requirements. The jitter buffer's set point is configured at 28 milliseconds. Adding the conversion delay of 4 milliseconds for a 64 kbps relay yields a 32 milliseconds total delay, which meets to the 2 cycle (based on 60 Hz, or 16.67 ms/cycle) requirement for LCDP.

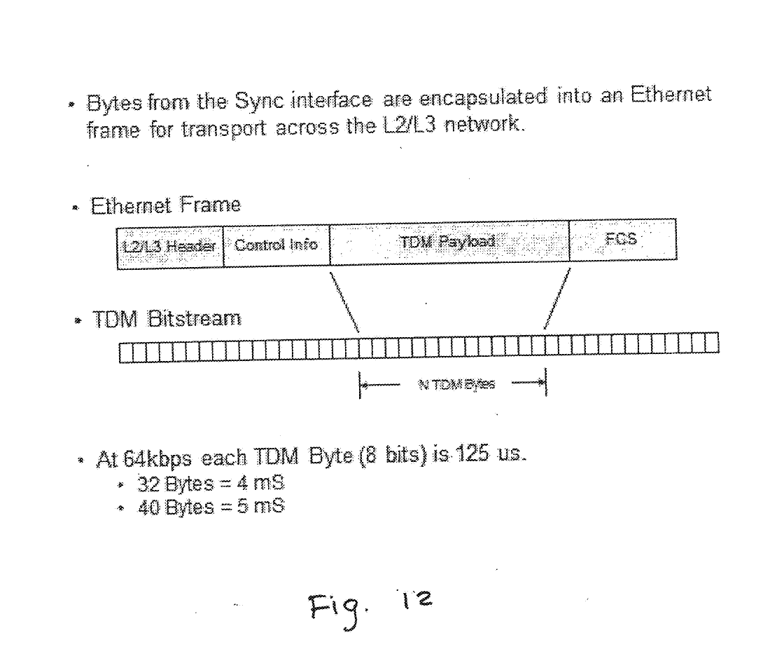

FIG. 12 is a diagram that illustrates how a TDM frame is being encapsulated inside an Ethernet packet. The TDM payload of 32 bytes over a 64 kbps interface takes 4 milliseconds to transfer.

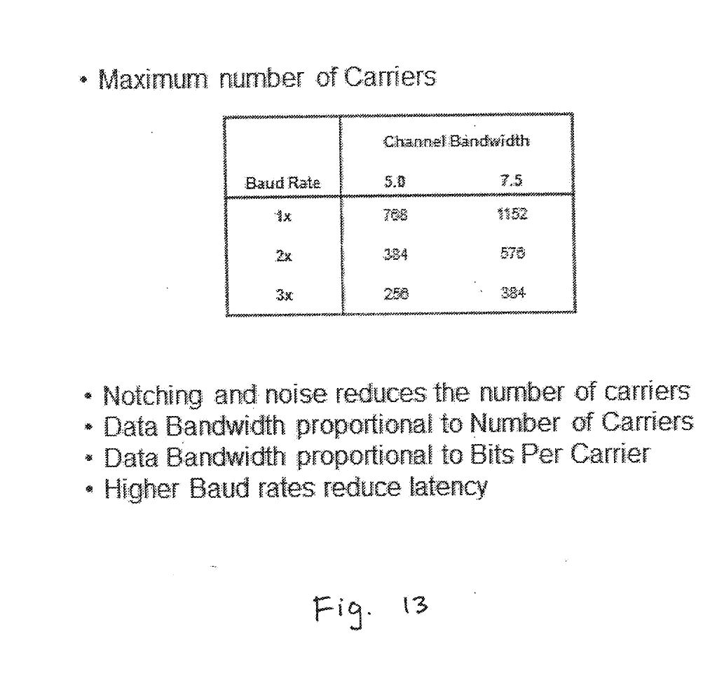

FIG. 13 is a chart that shows the number of carriers in a BPLC modem under various configurations. Having more bandwidth will provide more carriers since each carrier is allocated a specific frequency. In this table a 5 MHz bandwidth will have 758 carriers while a 7.5 MHz bandwidth will have 1,152 carriers. Increasing the baud rate of the modem will reduce the latency but the tradeoff is the reduction of the numbers of carriers (second and third lines). External events such as in-band noise and narrowband transmitters can reduce the numbers of available carriers.

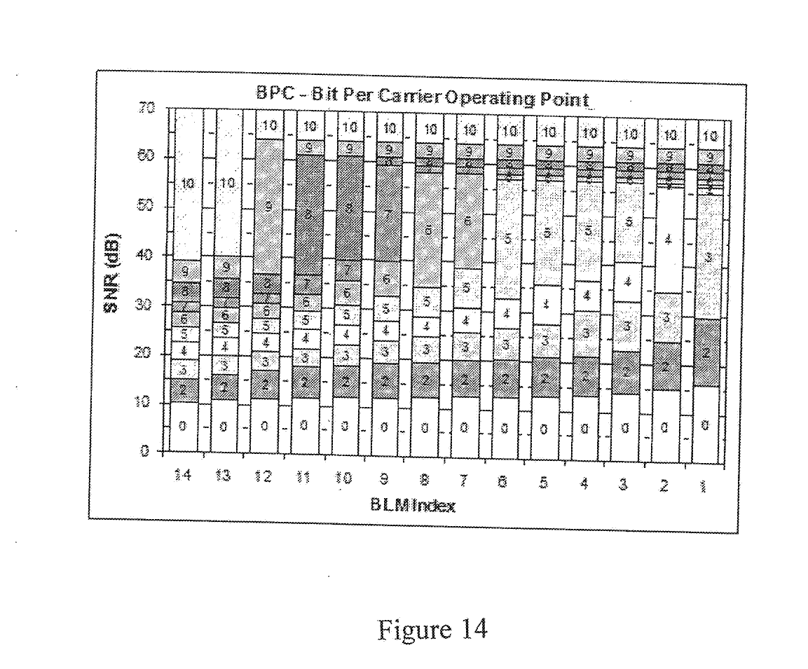

FIG. 14 is a chart that illustrates a Bits per Carrier (BPC) map of a BPLC modem. The BPLC modem can be configured to operate at various Bit Error Rate (BER) settings. Under normal conditions, the modem will attempt to operate at a bit error rate that provides the highest possible Signal-to-Noise Ratio (SNR). This is implemented in a firmware algorithm inside the BPLC modem that makes dynamic adjustments, for example. It is possible to fix the BER rate at a low BPC value (such as 2) which will provide an SNR margin of tens of dB. The SNR margin can be used to modify bandwidth for increased stability of the communications channel and to reduce jitter. A configuration setting in the BPLC modem can be used to reduce latency and jitter of the BPLC communications channel. In one embodiment of the present invention, a multi-port intelligent switch is used as a traffic cop between BPLC modems and the TDM-to-Ethernet converters (see FIG. 3).

In summary, the present invention provides a method and a system for providing a reliable communications channel for digital Line Current Differential Protection (LCDP).

According to an embodiment of the present invention, a BPLC communications channel is provided between a first end and a second end of high voltage transmission lines for digital LCDP wherein each of the first end and the second end has a digital relay for detecting a line fault. The BPLC communications channel comprises a first BPLC gateway device connected to the digital relay on the first end and a second BPLC gateway device connected to the digital relay on the second end. The BPLC gateway device is configured to provide a communications channel over the high voltage transmission lines as a fast communications channel between the digital relay at the first end and the digital relay at the second end.

The BPLC communications channel can be implemented over existing serial and fiber interfaces in a seamless plug and play mode that does not require any configuration changes in the digital relay. The connection between the BPLC gateway devices to the digital relays can be carried out using 64 kbps or 128 kbps serial TDM (Time Division Multiplexing) synchronous communications. TDM-to-Ethernet protocol converters can be used for the connection. The converter is configured to convert a TDM frame to an Ethernet packet and vice versa while maintaining clock information and synchronization.

According to an embodiment of the present invention, jitter buffering is implemented using jitter buffers to smooth the Ethernet communications and deliver a deterministic 64 kbps or 128 kbps data stream. The jitter buffer can have a center set point and special controls to detect high and low thresholds (overshoot and undershoot conditions) and resetting the jitter buffer to maintain normal operation.

According to an embodiment of the present invention, a configuration setting that slows down the BPLC modem is used to adapt to a 64 kbps or 128 kbps data stream.

According to an embodiment of the present invention, Bits per Carrier (BPC) values of the BPLC modem are used to increase Signal to Noise ratio (SNR) and trade bandwidth for stability. According to a different embodiment of the present invention, a configuration setting in the BPLC modem is used to minimize latency and jitter. A multi-port intelligent Ethernet switch is used as a traffic cop between the BPLC modems and the TDM-to-Ethernet converters.

According to an embodiment of the present invention, quality of service (QoS) is used for data path optimizations per each Ethernet port.

According to an embodiment of the present invention, the phase combiners are configured to provide common mode noise cancellation and radiated emission reduction.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method for connecting to line protection relays and providing a digital communications channel between a first end and a second end of high voltage transmission lines for Line Current Differential Protection (LCDP), wherein the line protection relays comprise a first protection relay at the first end and a second protection relay at the second end, said method comprising:
connecting a first gateway device to the first protection relay and connecting a second gateway device to the second protection relay, the first gateway device and the second gateway device configured to communicate with each other over the high voltage transmission lines so as to provide the communications channel between the first protection relay and the second protection relay.

2. The method according to claim 1, wherein each of the protection relays is a digital relay over existing serial and fiber interfaces connecting between the first end and the second end.

3. The method according to claim 1, wherein the first gateway device and the second gateway device each comprises a Broadband Power Line Carrier (BPLC) device, the BPLC device comprising a coupling device configured to transmit communication signals to the high voltage transmission lines and to receive communication signals from the high voltage transmission lines.

4. The method according to claim 1, wherein each of the protection relays is a digital relay configured for serial time divisional multiplexing (TDM) synchronous communications.

5. The method according to claim 4, wherein the serial time divisional multiplexing synchronous communications use a 64 Kbps to 128 Kbps communication rate.

6. The method according to claim 4, further comprising converting the TDM synchronous communications to an Ethernet protocol at the first end, and converting the Ethernet protocol to the TDM synchronous communications at the second end of the high voltage transmission lines for communications from the first end to the second end, and vice versa for communications from the second end to the first end.

7. The method according to claim 6, further comprising jitter buffering the communications from the first end to the second end and vice versa, so as to reduce jitter associated with said communications.

8. The method according to claim 7, wherein the jitter buffering has a center set point and is configured to detect high (overshoot) and low (undershoot) conditions and to reset an associated jitter buffer for maintaining nominal operation of the communications channel.

9. The method according to claim 8, wherein the first gateway device and the second gateway device each comprises a modem, said method further comprising use of configuration settings to reduce the speed of the modem so as to adapt to a 64 Kbps or 128 Kbps data stream.

10. The method according to claim 9, wherein bits per carrier (BPC) values of the modem are used to increase a signal-to-noise ratio (SNR) so as to modify bandwidth for increased stability of the communications channel.

11. The method according to claim 10, wherein the first gateway device and the second gateway device each comprises a Broadband Power Line Carrier (BPLC) device, the BPLC comprising a coupling device configured to transmit communication signals to the high voltage transmission lines and to receive communication signals from the high voltage transmission lines, wherein a configuration setting in the modem is used to reduce latency and jitter of the communications channel.

12. The method according to claim 11, wherein the first gateway device and the second gateway device each comprises a multi-port Ethernet switch configured as a traffic cop in the converting from the TDM synchronous communications to the Ethernet protocol and from the Ethernet protocol to the TDM synchronous communications.

13. The method according to claim 11, further comprising use of phase combiners in the coupling device so as to provide a common mode noise cancellation and radiated emission reduction along said communications channel.

14. A system for connecting to line protection relays and providing a communications channel between a first end and a second end of high voltage transmission lines for digital Line Current Differential Protection (LCDP), wherein the line protection relays comprise a first protection relay at the first end and a second protection relay at the second end, said system comprising:
a first gateway device connected to the first protection relay; and
a second gateway device connected to the second protection relay, the first gateway device and the second gateway device configured to communicate with each other over the high voltage transmission lines so as to provide the communications channel between the first protection relay and the second protection relay.

15. The system according to claim 14, wherein the first gateway device and the second gateway device each comprises a Broadband Power Line Carrier (BPLC) device, the BPLC device comprising a coupling device configured to transmit communication signals to the high voltage transmission lines and to receive communication signals from the high voltage transmission lines.

16. The system according to claim 14, wherein the communication signals are delivered over two or three phases of the high voltage transmission lines, the BPLC device further comprising a combiner configured to combine the communication signals from the two or three phases of high voltage transmission lines.

17. The system according to claim 14, wherein the first protection relay and the second protection relay each comprises a digital relay configured for serial time divisional multiplexing (TDM) synchronous communications.

18. The system according to claim 17, wherein the serial time divisional multiplexing synchronous communications use a 64 Kbps to 128 Kbps communication rate.

19. The system according to claim 17, wherein the BPLC device is configured to
convert the TDM synchronous communications to an Ethernet protocol at the first end of the high voltage transmission lines, and to convert the Ethernet protocol to the TDM synchronous communications at the second end of the high voltage transmission lines for communications from the first end to the second end, and vice versa for communications from the second end to the first end.

20. The system according to claim 19, further comprising a jitter buffer configured to reduce jitter in the communications between the first end and the second end of the high voltage transmission lines.
